(19) United States
(12) Patent Application Publication
(10) Pub. No.: US 2008/0148200 A1
(43) Pub. Date: Jun. 19, 2008

(54) METHOD FOR CHECKING THE LAYOUT OF AN INTEGRATED CIRCUIT

(76) Inventors: Christian Von Mueffling, Munich (DE); Thomas Roessler, Munich (DE)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/610,945

(22) Filed: Dec. 14, 2006

(51) Int. Cl. G06F 11/00

(52) U.S. Cl. 716/5

(57) ABSTRACT

According to one aspect, a method for checking the layout of an integrated circuit or integrated circuit mask comprising a plurality of objects, said method comprising the steps of selecting from the plurality of objects a reference object in the layout, selecting from the plurality of objects a displacement object which is different from said reference object, and determining the relative position of said displacement object with respect to the reference object.

### BACKGROUND OF THE INVENTION

This description is directed generally to a method for checking the layout of an integrated circuit.

For advanced semiconductor technologies, the conventionally used geometric design rule checks are not sufficient to ensure manufacturability. In particular, undesired process effects of a lithographic nature, for example, cannot be evaluated. Therefore, additional properties of the layout need to be determined. In one aspect, the relative position between two objects or patterns of a layout of an integrated circuit needs to be determined. Moreover, the relative position of simple combined structures needs to be determined and controlled.

### SUMMARY OF THE INVENTION

According to one aspect, a method for checking the layout of an integrated circuit or circuit mask is provided, said layout comprising a plurality of objects, said method comprising the steps of:

selecting from the plurality of objects a reference object in the layout;

selecting from the plurality of objects a displacement object being different from said reference object; and

determining the relative position of said displacement object with respect to the reference object.

According to another aspect, there is provided a method for making an integrated circuit formed by steps comprising directing patterning radiation at a device precursor, including the step of checking the layout of said integrated circuit, said layout comprising a plurality of objects, wherein said step of checking the layout of said integrated circuit comprises the steps of:

selecting from the plurality of objects a reference object in the layout;

selecting from the plurality of objects a displacement object being different from said reference object; and

determining the relative position of said displacement object with respect to the reference object.

According to a further aspect, there is provided an integrated circuit formed by steps comprising directing patterned radiation having a layout at a device precursor, with said layout comprising a plurality of objects and being checked by steps comprising:

selecting from the plurality of objects a reference object in the layout;

selecting from the plurality of objects a displacement object being different from said reference object; and

determining the relative position of said displacement object with respect to the reference object.

According to yet a further aspect, there is provided an integrated circuit in which the design included checking a layout of said integrated circuit, said layout comprising a plurality of objects, said checking comprising the steps:

selecting from the plurality of objects a reference object in the layout;

selecting from the plurality of objects a displacement object being different from said reference object; and

determining the relative position of said displacement object with respect to the reference object.

According to another aspect, there is provided a method for checking the layout of an integrated circuit, said layout comprising a plurality of patterns, said method comprising the steps of:

providing a graphical and/or non-graphical representation of at least one pattern;

selecting from the provided patterns a reference pattern; and

performing the following steps for at least one instance of said reference pattern in said layout:
determining at least one displacement pattern; and
for each determined displacement pattern, determining the relative position between said instance of said reference pattern and said displacement pattern.

According to a further aspect, there is provided a method for making an integrated circuit formed by steps comprising directing patterning radiation at a device precursor, including the step of checking the layout of said integrated circuit, said layout comprising a plurality of patterns, wherein said step of checking the layout of said integrated circuit comprises the steps of:

providing a graphical and/or non-graphical representation of at least one pattern;

selecting from the provided patterns a reference pattern; and

performing the following steps for at least one instance of said reference pattern in said layout:
determining at least one displacement pattern; and
for each determined displacement pattern, determining the relative position between said instance of said reference pattern and said displacement pattern.

According to another aspect, there is provided an integrated circuit formed by steps comprising directing patterned radiation having a layout at a device precursor, with said layout comprising a plurality of patterns checked by steps comprising:

providing a graphical and/or non-graphical representation of at least one pattern;

selecting from the provided patterns a reference pattern; and

performing the following steps for at least one instance of said reference pattern in said layout:
determining at least one displacement pattern; and
for each determined displacement pattern, determining the relative position between said instance of said reference pattern and said displacement pattern.

According to yet another aspect, there is provided an integrated circuit in which the design included checking a layout of said integrated circuit, said layout comprising a plurality of patterns, said checking comprising the steps of:

providing a graphical and/or non-graphical representation of at least one pattern;

selecting from the provided patterns a reference pattern; and

performing the following steps for at least one instance of said reference pattern in said layout:
determining at least one displacement pattern; and
for each determined displacement pattern, determining the relative position between said instance of said reference pattern and said displacement pattern.

According to yet another aspect, there is provided a computer program comprising program code means for performing the steps of any one of one of the above methods when said program is run on a computer.

According to yet another aspect, there is provided a computer program product comprising program code means stored on a computer readable medium for performing any one of one of the above methods.

According to yet another aspect, a device for checking the layout of an integrated circuit or integrated circuit mask, said layout comprising a plurality of objects, said device comprising:

a selecting unit for selecting from the plurality of objects a reference object in the layout and a displacement object which is different from said reference object; and

a determining unit for determining the relative position of said displacement object with respect to the reference object.

According to yet another aspect, a device for checking the layout of an integrated circuit or integrated circuit mask, said layout comprising a plurality of patterns, said device comprising:

a graphical and/or non-graphical representation of at least one pattern; and

a determining unit for performing the following steps:
selecting from said graphical and/or non-graphical representation a reference pattern; and
performing the following steps for at least one instance of said reference pattern in said layout:
   determining at least one displacement pattern; and
   for each determined displacement pattern, determining the relative position between said instance of said reference pattern and said displacement pattern.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a device for checking an integrated circuit layout according to a first example;

FIG. 2 shows a flow diagram of a method for checking an integrated circuit layout according to the first example;

FIG. 3 shows a device for checking an integrated circuit layout according to a second example;

FIG. 4 shows a flow diagram of a method for checking an integrated circuit layout according to the second example;

FIG. 5 shows the result of a lithographical simulation for a layout in which the distance between two rectangular vias has been changed; and

FIG. 6 shows two arrangements of objects.

### DETAILED DESCRIPTION OF THE PREFERRED EMBODIMENT

In the following a detailed description of examples will be given with reference to the drawings.

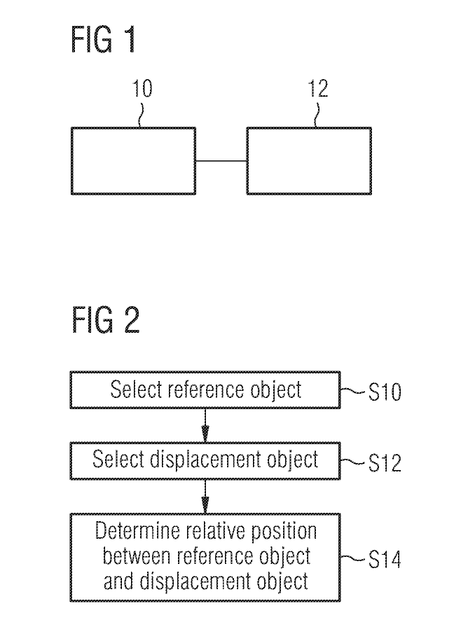

A first example will be described with reference to FIGS. 1 and 2.

FIG. 1 shows a device for checking an integrated circuit layout according to one example.

The device shown in FIG. 1 comprises a selecting unit 10 and a determining unit 12. Said selecting unit 10 selects a reference object from a plurality of objects in a layout of an integrated circuit. Moreover, said selecting unit 10 selects as displacement object being different from said reference object. Said displacement object may fulfill a predetermined condition with respect to the reference object. Said determining unit 12 determines the relative position of said displacement object with respect to the reference object.

The layout of an integrated circuit, also known as IC layout or IC mask layout, is the representation of an integrated circuit in terms of planar geometric shapes that correspond to shapes or polygons actually drawn on photomasks used in semiconductor device fabrication. In the layout, an electric element of the integrated circuit may be depicted by a plurality of polygons, edges, edge pairs or any other suitable elements. The objects which are to be evaluated by the above device may comprise one or more polygons, edges, edge pairs and/or other suitable elements of the layout.

The layout may alternatively be formed without the use of a photomask, as in the case of direct-draw electron or ion beam radiation, for example. In that case, the radiation beam is directed sequentially over a device precursor to form the patterns of the desired layout. Hence, the patterning, whether by a mask or by directing the radiation beam, imparts a layout to the devices formed on the integrated circuit. A multiplicity of masks or radiation beam exposure operations is typically used to form a multiplicity of patterned levels on the device precursor in order to form the integrated circuit, according to principles known in the art.

FIG. 2 shows a flow diagram of an example of a method for checking the layout of an integrated circuit.

In a first step S10, a reference object is selected from the plurality of objects of the layout. Then a displacement object for which the relative position to the reference object is to be determined is selected (Step S 12). The displacement object is selected such that it may fulfill a predetermined condition with respect to the reference object. Such a predetermined condition may be that the displacement object lies within a predetermined area or radius around the reference object. Another condition may be that the displacement object lies within direct line of sight to the reference object, i.e. that no other object is provided between the displacement object and the reference object. Any other condition of interest defining a relation or condition between objects may be foreseen.

In step S14, the relative position between the selected objects is determined. The relative position may be determined by determining the displacement vector between the reference object and the displacement object.

In an additional step (not shown), the displacement vector may be evaluated. For this evaluation, it may be determined whether the displacement vector is comprised in an allowable set or region of displacement vectors. An allowable set of displacement vectors may be determined in advance by experiment or simulation. In case the displacement vector is not comprised in the allowable set of displacement vectors, the respective objects may be marked and/or stored for further evaluation.

In one alternative, the displacement vector may be determined between reference points of the reference object and displacement object. Such a reference point may be the center or one corner of the bounding box of the objects. Any other suitable reference point may be considered.

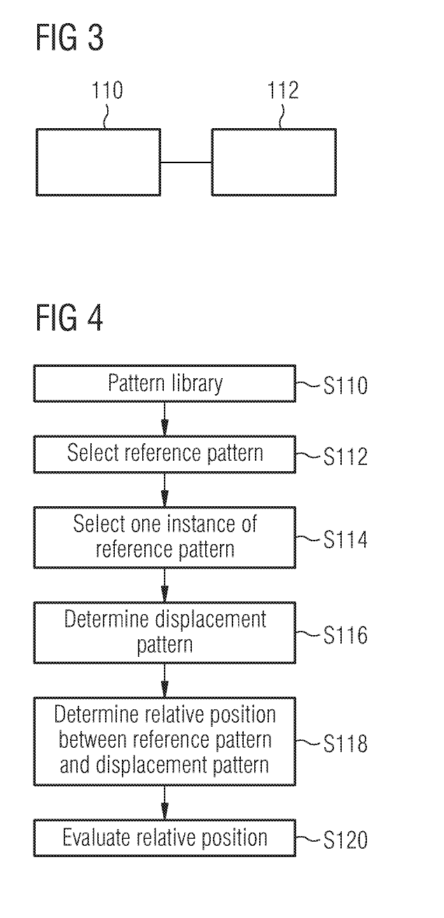

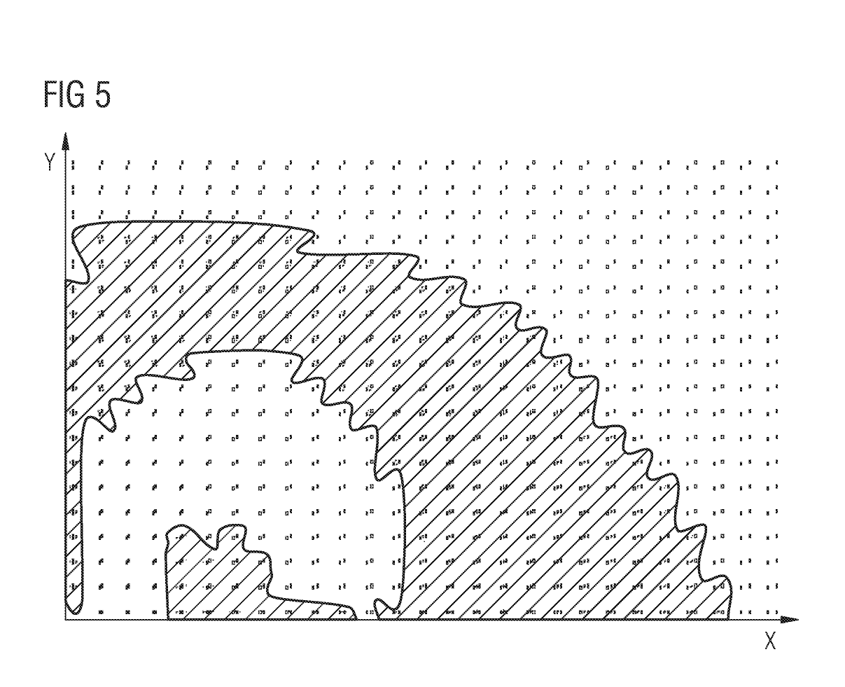

A second example will be described with reference to FIGS. 3 and 4.

FIG. 3 shows a device for checking an integrated circuit layout according to the second example.

The device for checking the layout of an integrated circuit may comprise a pattern library 110 and a determining unit 112. The layout of the integrated circuit comprises a plurality of patterns. A pattern may comprise one or more polygons and/or edges of the integrated circuit layout. In particular, a pattern may be any structure of the layout which is of interest to be examined. Such structures may be single polygons or composed of a plurality of polygons, edges, edge pairs and/or other suitable elements. The pattern library 110 may comprise at least one pattern. The patterns comprised in the pattern library 110 may be patterns which can be found in said layout. In one alternative, representatives of all different patterns present in said layout may be stored in the pattern library 110. Alternatively, only patterns which are of interest for the respective analysis are stored in the pattern library 110. Moreover, any kind of pattern may be stored in the pattern library 110. The pattern library 110 may also at least partly contain patterns which are not present in the layout. Thus, the pattern library 110 may be a general collection of patterns which may be used in the design of integrated circuits. In the pattern library 110, the patterns may be given in any suitable graphic or non-graphic format.

The determining unit 112 is suitable for performing the steps of selecting, from said pattern library 110, a reference pattern and performing a sequence of steps for at least one instance of said reference pattern in said layout. An instance of a pattern is a specific pattern in the layout corresponding to the selected reference pattern. Thus, an instance of a reference pattern in the layout is one particular specific representation of the reference pattern in the layout. In other words, the description of the reference pattern as such defines a pattern in general, whereas the instance of a pattern in the layout specifies one particular pattern corresponding to the reference pattern at a specific location in the layout. The sequence of steps comprises determining at least one displacement pattern, said displacement pattern may fulfill a predetermined condition with respect to said instance of said reference pattern, for each determined displacement pattern, determining the relative position between said instance of said reference pattern and said displacement pattern, and evaluating whether or not the relative position fulfills a predetermined condition.

In an alternative example, the pattern library 110 may be substituted or supplemented by a means for determining at least one pattern of the layout. All patterns or all different patterns of the layout may be determined. The determined pattern may be directly used for the further processing as described above. Alternatively, the determined patterns may be stored. A predefined subgroup or all of the determined patterns may be used as reference pattern and/or displacement pattern.

Moreover, any other suitable collection containing a graphical and/or non-graphical representation of patterns may be used as a basis from which a reference pattern and/or displacement pattern may be selected.

FIG. 4 shows a flow diagram of the second example of a method for checking the layout of an integrated circuit.

In a first step S110, a pattern library is provided. The pattern library may contain essentially all patterns which are to be examined or analyzed. As discussed above, any other suitable collection containing patterns may be used.

In step S112, a reference pattern is selected or determined. The reference pattern is the pattern which is used as a starting point for determining the relative position to other patterns. The reference pattern may be selected from the pattern library.

Additionally (not shown), a reference point of the patterns to be evaluated may be defined. The reference point is a point of a pattern which is used for determining the relative position. The reference point may be the center or one corner of the bounding box of the objects or patterns. Any other suitable reference point may be considered.

In step S114, an instance of the selected reference pattern is selected or located in the layout. That is, one specific part or section of the layout corresponding to the reference pattern is selected. Subsequently, a displacement pattern, for which the relative position to the reference pattern is to be determined, is determined (Step S116). The displacement pattern may be selected to fulfill a predetermined condition with respect to the reference pattern. Such a predetermined condition may be that the displacement pattern lies within a predetermined area or radius around the reference pattern. Another condition may be that the displacement pattern lies within direct line of sight to the reference pattern, i.e. that no other pattern is provided between the displacement pattern and the reference pattern. Any other condition of interest defining a relation between patterns is also contemplated.

In step S118, the relative position between the instance of the reference pattern and the displacement pattern is determined. For the determination of the relative position, a displacement vector between the reference pattern and the displacement pattern may be used. Then, the relative position may be evaluated (step S120). In particular, it is evaluated whether the displacement vector is comprised in a predetermined allowable set of region of allowable displacement vectors. During the evaluation, pairs of patterns for which the displacement vector does not lie in the predetermined allowable set or region of allowable displacement vectors may be marked and submitted to a further evaluation. In particular, the layout may be changed in order to avoid pattern pairs being in non-allowable positions with respect to each other.

The set or group or region of allowable and non-allowable displacement vectors may be determined in advance for particular pairs of patterns. This may be done by simulation or experiment.

Steps S116 to S120 may be repeated for one, more than one or all displacement patterns fulfilling the predetermined condition with respect to the instance of the reference pattern. Furthermore, steps S114 to S120 may be performed for one or more or all instances of the reference pattern. The evaluation step S120 may alternatively be performed only after having determined the relative position of a plurality of patterns.

For the embodiments described above, the patterns or objects being analyzed or checked may be on the same mask level, or alternatively, they may be on different mask levels. Moreover, the above described methods may be applied to checking the layout of an integrated circuit mask.

Moreover, the step of determining the relative position and/or determining the allowable displacement vector may be performed so as to avoid the formation of extraneous artifacts due to under or over exposure. Such extraneous artifacts may be a contact window. For example, due to varying conditions during manufacture, errors may occur.

A method for making or manufacturing an integrated circuit may comprise directing patterned radiation having a layout at a device precursor. Said layout may be checked by one of the above described methods. Said step of directing patterned radiation may comprise any suitable kind of lithography, in particular lithography for defining lateral structures or structuring, such as optical shadow mask lithography or electron beam lithography. Such lateral structures or structuring may be at least in part defined by or comprise objects, patterns or polygons. With the above described manufacturing method, objects, patterns or polygons comprised in the structure, such as a lateral structure, may be defined in the same step of directing patterned radiation or in different steps of directing patterned radiation. Thus, a first step of directing patterned radiation may comprise defining a first structure at least in part defined by or comprising a reference object or pattern, and a second step of directing patterned radiation may comprise defining a second structure at least in part defined by or comprising a displacement object or pattern.

Furthermore, an integrated circuit may comprise a layout. Said layout may be checked by one of the above described methods.

The above described methods may be embodied in a computer program comprising program code means for performing the methods steps. Alternatively or additionally, the described methods may be embodied in a computer program product comprising program code means stored on a computer readable medium for performing any one of one of the above methods. The above described methods may also be provided as a subscription service for the user.

As an example, the via or contact hole layer of an advanced semiconductor technology can be regarded. Because of the technological solutions which are necessary to provide contacts of the required dimension, in some particular arrangements of vias, so-called “side lobes” can occur. These side lobes lead to undesired occurrence of additional contacts which in the worst case can destroy the functionality of the integrated circuit.

FIG. 5 shows the result of a lithographical simulation for a layout in which the relative position between two rectangular vias has been changed. Along the x-axis, the distance in the x-direction has been increased, and respectively along the y-axis, the distance in y-direction has been increased. The hatched regions mark relative positions of two vias, and thus displacement vectors, for which side lobes occur. As can be seen from FIG. 5, the occurrence of side lobes cannot be predicted by merely determining the distance between two vias.

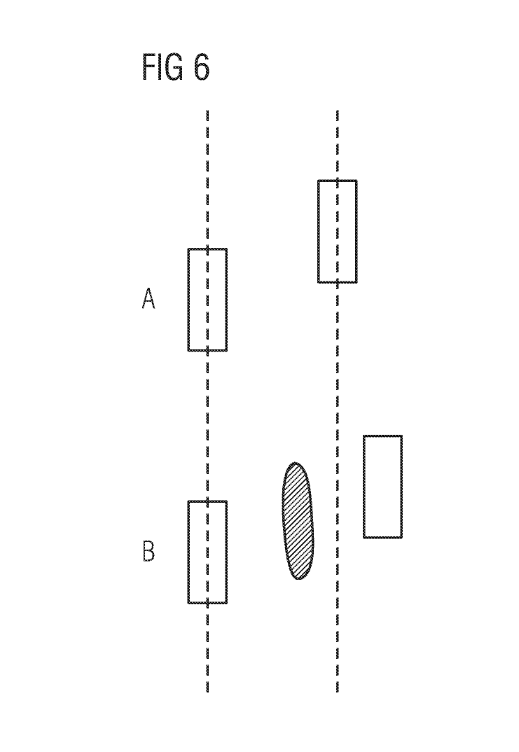

FIG. 6 shows another example in which two relative positions (A and B) of two patterns are shown. In case A, no side lobes occur, whereas in the arrangement in case B, a side lobe between the two patterns occurs. Such a side lobe may cause an undesired contact between the two patterns which may cause a malfunction of the integrated circuit.

By determining pattern arrangements in the layout of the integrated circuit for which undesired behavior of the integrated circuit may occur already at the design stage and not only when testing the actual integrated circuit, unnecessary costs be avoided. Moreover, complex lithographic simulations can be avoided, thus saving time and computing resources.

The above described and other examples could be implemented in digital electronic circuitry, or in computer hardware, firmware, software, or in combinations of them. In particular, the examples could be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

Method steps of the described and other examples could be performed by one or more programmable processors executing a computer program to perform functions of the described and other examples by operating on input data and generating output. Method steps could also be performed by, and apparatus of the described and other examples could be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

To provide for interaction with a user, the described and other examples could be implemented on a computer having a display device such as a CRT (cathode ray tube) or LCD (liquid crystal display) monitor for displaying information to the user and a keyboard and a pointing device such as a mouse or a trackball by which the user can provide input to the computer. Other kinds of devices could be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The described and other examples could also be implemented in a computing system that includes a back-end component, e.g., as a data server, or that includes a middleware component, e.g., an application server, or that includes a front-end component, e.g., a client computer having a graphical user interface or an Web browser through which a user can interact with an implementation, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of examples and implementations have been described. Other examples and implementations may, in particular, comprise one or more of the above features. Nevertheless, it will be understood that various modifications may be made. Accordingly, other implementations are within the scope of the following claims.

What is claimed is:

1. A method of checking a layout of an integrated circuit or integrated circuit mask, the layout comprising a plurality of objects, the method comprising:
selecting from the plurality of objects a reference object in the layout;
selecting from the plurality of objects a displacement object which is different from the reference object; and
determining a relative position of the displacement object with respect to the reference object.

2. The method according to claim 1, wherein the displacement object is selected such that it fulfills a predetermined condition with respect to the reference object.

3. The method according to claim 2, wherein the predetermined condition is a predetermined geometric condition.

4. The method according to claim 1, further comprising evaluating a determination result.

5. The method according to claim 1, wherein the relative position is determined by determining a displacement vector between the reference object and the displacement object

6. The method according to claim 5, further comprising evaluating a determination result, wherein evaluating the determination result comprises evaluating whether the displacement vector is comprised within a predetermined set of allowable displacement vectors.

7. The method according to claim 6, wherein, when the displacement vector is not comprised within the predetermined set of allowable displacement vectors, at least one of the following is performed:
the reference object and the displacement object are marked in the layout; and
the reference object and the displacement object are stored.

8. The method according to claim 6, wherein the set of allowable displacement vectors is determined in advance by at least one of experiment and simulation.

9. The method according to claim 1, wherein the relative position of the displacement object with respect to the reference object is determined between reference points of the objects.

10. The method according to claim 1, wherein the reference object and the displacement object are on different mask levels.

11. The method according to claim 1, wherein the reference object and the displacement object are on the same mask level.

12. The method according to claim 1, wherein the step of determining the relative position is performed so as to avoid a formation of extraneous artifacts due to one of under exposure and over exposure.

13. The method according to claim 12, wherein the extraneous artifact is a contact window.

14. A method for making an integrated circuit, comprising directing patterning radiation at a device precursor, and checking a layout of the integrated circuit, the layout comprising a plurality of objects, wherein the step of checking the layout of the integrated circuit comprises:
selecting from the plurality of objects a reference object in the layout;
selecting from the plurality of objects a displacement object which is different from the reference object; and
determining a relative position of the displacement object with respect to the reference object.

15. The method according to claim 14, wherein the displacement object is selected such that it fulfills a predetermined condition with respect to the reference object.

16. The method according to claim 15, wherein the predetermined condition is a predetermined geometric condition.

17. The method according to claim 14, further comprising evaluating a determination result.

18. The method according to claim 14, wherein the relative position is determined by determining the displacement vector between the reference object and the displacement object

19. The method according to claim 18, further comprising evaluating a determination result, wherein the step of evaluating the determination result comprises evaluating whether the displacement vector is comprised within a predetermined set of allowable displacement vectors.

20. The method according to claim 19, wherein, when the displacement vector is not comprised within the predetermined set of allowable displacement vectors, at least one of the following is performed:
the reference object and the displacement object are marked in the layout; and
the reference object and the displacement object are stored.

21. The method according to claim 19, wherein the set of allowable displacement vectors is determined in advance by at least one of experiment and simulation.

22. The method according to claim 14, wherein the relative position of the displacement object with respect to the reference object is determined between reference points of the objects.

23. The method according to claim 14, wherein the reference object and the displacement object are on different mask levels.

24. The method according to claim 14, wherein the reference object and the displacement object are on the same mask level.

25. The method according to claim 14, wherein the step of determining the relative position is performed so as to avoid a formation of extraneous artifacts due to one of under exposure and over exposure.

26. The method according to claim 25, wherein the extraneous artifact is a contact window.

27. A method of checking a layout of an integrated circuit formed by steps comprising directing patterned radiation having the layout at a device precursor, with the layout comprising a plurality of objects and wherein the method comprises:
selecting from the plurality of objects a reference object in the layout;
selecting from the plurality of objects a displacement object which is different from the reference object; and
determining a relative position of the displacement object with respect to the reference object.

28. An integrated circuit in which a design process for which includes checking a layout of the integrated circuit, the layout comprising a plurality of objects, the checking comprising the steps of:
selecting from the plurality of objects a reference object in the layout;
selecting from the plurality of objects a displacement object which is different from the reference object; and
determining a relative position of the displacement object with respect to the reference object.

29. A method of checking a layout of an integrated circuit or integrated circuit mask, the layout comprising a plurality of patterns, the method comprising:
providing at least one of a graphical representation and a non-graphical representation of at least one pattern;
selecting from the at least one provided patterns a reference pattern; and
performing the following steps for at least one instance of the reference pattern in the layout:
determining at least one displacement pattern; and
for each determined displacement pattern, determining a relative position between the instance of the reference pattern and the displacement pattern.

30. The method according to claim 29, wherein the step of providing the representation of at least one pattern comprises providing a pattern library containing at least one of the graphical representation and the non-graphical representation for the at least one pattern.

31. The method according to claim 30, wherein the displacement pattern is selected from the pattern library.

32. The method according to claim 29, wherein the step of providing the representation of at least one pattern comprises the step of determining at least one pattern of the layout.

33. The method according to claim 32, wherein all patterns of the layout are determined, and wherein each determined pattern is used as a reference pattern.

34. The method according to claim 33, wherein the displacement pattern is selected from the determined patterns of the layout.

35. The method according to claim 29, wherein the displacement pattern fulfills a predetermined condition with respect to the instance of the reference pattern.

36. The method according to claim 29, further comprising evaluating whether the relative position fulfills a predetermined condition.

37. The method according to claim 29, further comprising at least one of marking and storing the reference pattern and the displacement pattern when the relative position does not fulfill the predetermined condition.

38. The method according to claim 29, wherein the predetermined condition is a predetermined geometric condition.

39. The method according to claim 29, wherein the relative position is determined by determining a displacement vector between the instance of the reference pattern and the displacement pattern.

40. The method according to claim 36, wherein the relative position is determined by determining a displacement vector between the instance of the reference pattern and the displacement pattern, and wherein the step of evaluating comprises evaluating whether the displacement vector is comprised within a predetermined set of allowable displacement vectors.

41. The method according to claim 40, wherein, when the displacement vector is not comprised within the predetermined set of allowable displacement vectors, at least one of the following is performed:
the reference pattern and the displacement pattern are marked in the layout; and
the reference pattern and the displacement pattern are stored.

42. The method according to claim 40, wherein the set of allowable displacement vectors is determined in advance by at least one of experiment and simulation.

43. The method according to claim 29, wherein the relative position of the displacement pattern with respect to the reference pattern is determined between reference points of the objects.

44. The method according to claim 29, wherein the instance of the reference pattern and the displacement pattern are on different mask levels.

45. The method according to claim 29, wherein the instance of the reference pattern and the displacement pattern are on the same mask level.

46. The method according to claim 29, wherein the step of determining the relative position is performed so as to avoid a formation of extraneous artifacts due to one of under exposure and over exposure.

47. The method according to claim 46, wherein the extraneous artifact is a contact window.

48. A method for making an integrated circuit, comprising directing patterning radiation at a device precursor, and checking a layout of the integrated circuit, the layout comprising a plurality of patterns, wherein the step of checking the layout of the integrated circuit comprises:
providing at least one of a graphical representation and a non-graphical representation of at least one pattern;
selecting from the at least one provided patterns a reference pattern; and
performing the following steps for at least one instance of the reference pattern in the layout:
determining at least one displacement pattern; and
for each determined displacement pattern, determining a relative position between the instance of the reference pattern and the displacement pattern.

49. The method according to claim 48, wherein the step of providing the representation of at least one pattern comprises providing a pattern library containing at least one of the graphical representation and the non-graphical representation for the at least one pattern.

50. The method according to claim 49, wherein the displacement pattern is selected from the pattern library.

51. The method according to claim 48, wherein the step of providing the representation of at least one pattern comprises the step of determining at least one pattern of the layout.

52. The method according to claim 51, wherein all patterns of the layout are determined, and wherein each determined pattern is used as a reference pattern.

53. The method according to claim 52, wherein the displacement pattern is selected from the determined patterns of the layout.

54. The method according to claim 48, wherein the displacement pattern fulfills a predetermined condition with respect to the instance of the reference pattern.

55. The method according to claim 48, further comprising evaluating whether the relative position fulfills a predetermined condition.

56. The method according to claim 48, further comprising at least one of marking and storing the reference pattern and displacement pattern when the relative position does not fulfill the predetermined condition.

57. The method according to claim 48, wherein the predetermined condition is a predetermined geometric condition.

58. The method according to claim 48, wherein the relative position is determined by determining a displacement vector between the instance of the reference pattern and the displacement pattern

59. The method according to claim 58, further comprising evaluating whether the relative position fulfills a predetermined condition, wherein the step of evaluating comprises evaluating whether the displacement vector is comprised within a predetermined set of allowable displacement vectors.

60. The method according to claim 59, wherein, when the displacement vector is not comprised within the predetermined set of allowable displacement vectors, at least one of the following is performed:
the reference pattern and the displacement pattern are marked in the layout; and
the reference pattern and the displacement pattern are stored.

61. The method according to claim 59, wherein the set of allowable displacement vectors is determined in advance by at least one of experiment and simulation.

62. The method according to claim 48, wherein the relative position of the displacement pattern with respect to the reference pattern is determined between reference points of the objects.

63. The method according to claim 48, wherein the instance of the reference pattern and the displacement pattern are on different mask levels.

64. The method according to claim 48, wherein the instance of the reference pattern and the displacement pattern are on the same mask level.

65. The method according to claim 48, wherein the step of determining the relative position is performed so as to avoid a formation of extraneous artifacts due to one of under exposure and over exposure.

66. The method according to claim 65, wherein the extraneous artifact is a contact window.

67. A method of checking a layout of an integrated circuit formed by directing patterned radiation having the layout at a device precursor, with the layout comprising a plurality of patterns and wherein the method comprises:
providing at least one of a graphical representation and a non-graphical representation of at least one pattern;
selecting from the at least one provided patterns a reference pattern; and
performing the following steps for at least one instance of the reference pattern in the layout:
determining at least one displacement pattern; and
for each determined displacement pattern, determining a relative position between the instance of the reference pattern and the displacement pattern.

68. An integrated circuit in which a design process for which included checking a layout of the integrated circuit, the layout comprising a plurality of patterns, the checking comprising:
providing at least one of a graphical representation and a non-graphical representation of at least one pattern;
selecting from the at least one provided patterns a reference pattern; and
performing the following steps for at least one instance of the reference pattern in the layout:
determining at least one displacement pattern; and
for each determined displacement pattern, determining a relative position between the instance of the reference pattern and the displacement pattern.

69. A computer comprising a processor and a memory, the processor configured to perform the steps of any one of claims 1, 14, 29 or 48.

70. A computer program product comprising program code means stored on a computer readable medium for performing any one of the methods according to claims 1, 14, 29 or 48.

71. A device for checking a layout of an integrated circuit or integrated circuit mask, the layout comprising a plurality of objects, the device comprising:
a selecting unit for selecting from the plurality of objects a reference object in the layout and a displacement object which is different from the reference object; and
a determining unit for determining a relative position of the displacement object with respect to the reference object.

72. The device according to claim 71, wherein the determining unit is configured to evaluate a determination result.

73. The device according to claim 71, wherein the relative position is determined by determining a displacement vector between the reference object and the displacement object.

74. The device according to claim 73, wherein the determining unit is configured to evaluate a determination result, and wherein the step of evaluating the determination result comprises evaluating whether the displacement vector is comprised within a predetermined set of allowable displacement vectors.

75. The device according to claim 74, wherein, when the displacement vector is not comprised within the predetermined set of allowable displacement vectors, the device is configured to perform at least one of:
marking the reference object and the displacement object in the layout; and
storing the reference object and the displacement object.

76. The device according to claim 71, wherein the relative position of the displacement object with respect to the reference object is determined between reference points of the objects.

77. A device for checking the layout of an integrated circuit or integrated circuit mask, the layout comprising a plurality of patterns, the device comprising:
a providing unit for providing at least one of a graphical representation and a non-graphical representation of at least one pattern; and
a determining unit for performing the following steps:
selecting from the graphical and non-graphical representations a reference pattern;
performing the following steps for at least one instance of the reference pattern in the layout:
determining at least one displacement pattern; and
for each determined displacement pattern, determining a relative position between the instance of the reference pattern and the displacement pattern.

78. The device according to claim 77, wherein the providing unit is a pattern library.

79. The device according to claim 77, wherein the determining unit is configured to evaluate whether the relative position fulfills a predetermined condition.

80. The device according to claim 77, wherein the relative position is determined by determining a displacement vector between the instance of the reference pattern and the displacement pattern

81. The device according to claim 77, wherein the relative position of the displacement pattern with respect to the reference pattern is determined between reference points of the objects.
